(19) United States
(12) Patent Application Publication
(10) Pub. No.: US 2015/0300862 A1
(43) Pub. Date: Oct. 22, 2015

(54) Fouling Resistant Flow Manifold

(71) Applicant: COMMONWEALTH SCIENTIFIC AND INDUSTRIAL RESEARCH ORGANISATION, Campbell, Australian Capital Territory (AU)

(72) Inventors: Roger O'Halloran, Coburg (AU); Nigel Goodman, Box Hill (AU); Benny Kuan, Templestowe (AU)

(73) Assignee: COMMONWEALTH SCIENTIFIC AND INDUSTRIAL RESEARCH ORGANISATION, Campbell (AU)

(21) Appl. No.: 14/646,707

(22) PCT Filed: Nov. 25, 2013
(86) PCT No.: PCT/AU2013/001359

§ 371 Date: May 21, 2015

(30) Foreign Application Priority Data
Nov. 23, 2012 (AU) 2012905113

(51) Int. Cl. G01F 15/12; G01F 1/00

(52) U.S. Cl. CPC G01F 15/12; G01F 1/00

(57) ABSTRACT

A fouling resistant manifold (1) for mounting a fluid monitoring sensor used to monitor various fluid parameters of a fluid. The manifold (1) includes a fluid inlet (2) and a fluid outlet (3) connected by a fluid channel (4). A sensor mounting area (7) is provided for mounting a respective sensor module and flow deflection formation (9) is configured to control the velocity gradient of the fluid flow at the sensor mounting area (7) thereby inducing a localised increase in shear stress to the manifold surface wall. The increased wall shear reduces the tendency for suspended matter in the fluid to attach to the channel surface.

### FIELD OF THE INVENTION

The present invention relates generally to manifolds for sensor equipment used in monitoring the flow of liquids. While the invention is described with particular reference to sewage, effluent and grey water management, it may also be applied to other types of fluids.

### BACKGROUND OF THE INVENTION

The following discussion of the prior art is intended to facilitate an understanding of the invention and to enable the advantages of it to be more fully understood. It should be appreciated, however, that any reference to prior art throughout the specification should not be construed as an express or implied admission that such prior art is widely known or forms part of common general knowledge in the field.

Monitoring of fluids which contain solid, semi-solid, suspended or dissolved matter with sensors can be problematic. Many of these types of fluids include or carry material prone to accumulating on the internal surfaces of the pipes and manifolds used to transport the fluid and in which sensors are located. For instance, greasy and/or fatty fouling matter, biological/organic materials, scum, sludge and residues may adhere or accumulate on internal conduit surfaces. In the cases where sensors need physical contact with the fluid stream in order to function or are precisely calibrated to function through a known thickness and material of a manifold wall, matter accumulating on the face of the sensors or internal surfaces of the passageway, can often render them inoperative or erroneous.

The issue is exacerbated by prolonged exposure to such fluids such as during long-term and constant monitoring for management. Of particular concern are sewage, effluent and grey water management. However, fouling can also be problematic for other types of fluids from chemical build up in chemical manufacturing, storage and/or distribution, to the build up of biological and/or organic materials in for instance, marine or aquatic environments, and various components in food and dairy manufacture and processing.

One method of reducing fouling is to pump the fluid at very high flow rates so that the fluid itself sweeps away any matter build up. However achieving high flow rates is often not practical as it generally requires costly additional pumping equipment, up-rated conduits to cope with the higher driving pressures which can damage sensors. Moreover sensors may not function correctly at such flow rates.

Another method for addressing the problem of fouling requires regular maintenance of the sensor and manual cleaning. However, it is usually necessary to shut down the system so that the sensor and/or manifold can be disassembled and cleaned.

In some applications it may be possible to add chemical cleaners into the fluid flowing through the manifold, or through jets directed at sensor surfaces. However, the addition of cleaning chemicals in many cases may not be possible or may be expensive or undesirable.

Another method is to provide a mechanical wiper in the manifold to clean the sensor. However, such mechanical devices are prone to failure and usually add complexity and cost to the manifold.

Another solution involves the use of spray jets which spray a stream of liquid onto the sensor, whereby the stream spreads out radially from the point of impact to produce a thin, high velocity layer of cleaning fluid. However such wall jets are prone to damaging sensor surfaces, particularly sensors having delicate and/or flexible interfaces (e.g. polymer membranes). Moreover, often the jet can cause sensor error. In addition, these systems can be ineffective in submerged sensors and, like mechanical systems, add complexity and cost to the manifold.

It is an object of the present invention to overcome or substantially ameliorate one or more of the deficiencies of the prior art, or at least to provide a useful alternative.

### SUMMARY OF THE INVENTION

According to a first aspect, the invention provides a fouling resistant sensor manifold for directing a fluid to a sensor mounted on the manifold, the manifold including:

a fluid inlet;

a fluid outlet;

a fluid channel connecting the inlet to the outlet;

a manifold wall defining an inner channel surface including a sensor mounting area for mounting the sensor for exposure to fluid flowing through the channel;

a deflection formation disposed upstream of the sensor mounting area to accelerate a stream of the fluid, whereby a resultant change in velocity gradient of the fluid stream induces a localised increase in wall shear at the sensor mounting area, thereby in use to resist fouling of the sensor.

Preferably, the deflection formation includes one or more of: an elbow bend in the manifold channel; a constriction of the channel; a venturi formation; a baffle; a deflection surface; a deflection vane; a fin; a change in channel cross-sectional profile; a wall surface finish; channel rifling and/or a nozzle formation.

In one embodiment, the deflection formation includes a bend in the fluid channel. Preferably, the bend is between 45 degrees and around 135 degrees, more preferably between 60 degrees and around 120 degrees; and most preferably between 75 degrees and around 105 degrees. In one preferred embodiment, the bend is around 90 degrees.

In one embodiment, the deflection formation includes a constriction of the channel to accelerate the stream. Preferably, the constriction includes a nozzle having a nozzle inlet upstream of a nozzle outlet for directing the stream. Preferably, the nozzle tapers progressively from the nozzle inlet to the nozzle outlet.

In one embodiment, the nozzle includes a stepped change in cross sectional area between the nozzle inlet and the nozzle outlet.

The nozzle outlet may have a generally circular and/or elongate cross-sectional profile.

In one embodiment, the nozzle provides a cross-sectional area, nozzle reduction ratio of the channel cross-sectional area with respect to the nozzle outlet cross-sectional area of greater than 1. However preferably, the nozzle reduction ratio is greater than 4 and in some embodiments is preferably greater than 15.

The nozzle outlet may be generally centrally located within the channel or in one preferred embodiment, is offset from the centre of the channel.

The deflection formation may be an insert within the channel or may be formed integrally with the manifold wall.

In one preferred embodiment, the nozzle outlet is disposed upstream of a defection surface and adapted to direct the accelerated stream onto the deflection surface.

In another embodiment, the nozzle outlet is disposed upstream of a bend in the fluid channel to direct the accelerated stream into the bend. The bend may include a deflection surface.

In one embodiment, the deflection formation is adapted to initiate a downstream vortex flow.

Preferably, the wall shear at the sensor mounting area is greater than 25 Pa and however more preferably, the wall shear at the sensor mounting area is greater than 34 Pa.

In another aspect, the invention provides a fouling resistant sensor manifold for directing a fluid to a sensor mounted on the manifold, the manifold including:

a fluid inlet;

a fluid outlet;

a fluid channel connecting the inlet to the outlet, the channel having generally circular or square cross-section with a maximum width D of between around 7 mm and 15 cm;

a manifold wall defining an inner channel surface including a sensor mounting area for mounting the sensor;

a deflection formation disposed upstream of the sensor mounting area to accelerate a stream of the fluid, whereby a resultant change in velocity gradient of the fluid stream induces a localised increase in wall shear at the manifold wall within the sensor mounting area, thereby in use to resist fouling of the sensor, the deflection formation including an elbow bend in the channel defining an angular deflection of between 45 and around 135 degrees.

In one embodiment, the channel has a maximum width D of around 1.5 cm.

In one embodiment, the sensor mounting area is disposed within a distance of 5D downstream of the bend. However, preferably the sensor mounting area is disposed within a distance of 2D downstream of the bend.

Preferably, the deflection formation further includes a fluid nozzle having an upstream nozzle inlet and a downstream nozzle outlet, the nozzle disposed within the channel for directing a stream of fluid from the nozzle outlet into the bend. In one embodiment, the nozzle has a nozzle length L_{N} of around 3D.

In one embodiment, the nozzle outlet is disposed adjacent the channel way to direct the stream generally parallel to the wall.

Preferably, the nozzle outlet is spaced upstream the bend by a distance of between 0 and around 0.65 D.

In one embodiment, the nozzle provides a nozzle reduction ratio of the channel cross-section area to the outlet nozzle cross-section area (i.e. area to area ratio) of greater than around 4 and preferably, greater than around 15.

In one embodiment, the nozzle outlet is an elongate slot having a transverse width of between 0.03 D and around 0.2 D.

In one embodiment, the channel has a generally D-shaped cross section comprising a generally semi circular section opposed to a generally flat section.

Preferably, the generally flat section defines a generally planar sensor mounting area and the nozzle outlet is disposed adjacent the generally semi circular section.

Advantageously, in preferred embodiments, the invention provides a significant improvement in technology for long-term monitoring and control of wastewater treatment plants, and source control in sewer catchments.

### BRIEF DESCRIPTION OF THE DRAWINGS

Preferred embodiments of the invention will now be described, by way of example only, with reference to the accompanying drawings in which:

FIG. 1 is a perspective view of a manifold in accordance with a first embodiment of the invention;

FIG. 2 is a perspective view showing the internal volume of another manifold in accordance with the invention forming the internal channel;

FIG. 3 is a cross sectional view of the channel shown in FIG. 2;

FIG. 4 is a plan view of a manifold in accordance with another embodiment of the invention;

FIG. 5 is a top view graphical representation of the resultant wall shear mapped onto the channel surface in accordance with Example 1, wherein the channel includes a 90 degree elbow bend and the Figure includes a shading key indicating ranges of wall shear;

FIG. 6 is a side view graphical representation of the resultant wall shear mapped onto the channel surface in accordance with Example 2, wherein the channel includes a nozzle and the Figure includes a shading key indicating ranges of wall shear;

FIG. 7 is a top view graphical representation of the resultant wall shear mapped onto the channel surface in accordance with Example 2;

FIG. 8 is a cross-sectional view of the manifold channel of Example 2;

FIG. 9 is a top view graphical representation of the resultant wall shear mapped onto the channel surface in accordance with Example 3, wherein the channel includes a 90 degree elbow bend and a nozzle, and the Figure includes a shading key indicating ranges of wall shear;

FIG. 10 is a top view of the internal volume of the manifold channel surface of Example 3;

FIG. 11 is a side view of the internal volume of the manifold channel surface shown in Example 3;

FIG. 12 is a top view graphical representation of the resultant wall shear mapped onto the channel surface in accordance with Example 4, wherein the channel includes a 45 degree elbow bend and a nozzle, and the Figure includes a shading key indicating ranges of wall shear;

FIG. 13 is a top view graphical representation of the resultant wall shear mapped onto the channel surface in accordance with Example 5, wherein the channel includes a 135 degree elbow bend and a nozzle;

FIG. 14 is a top view graphical representation of the resultant wall shear mapped onto the channel surface in accordance with Example 6, wherein the Figure includes a shading key indicating ranges of wall shear;

FIG. 15 is a top view graphical representation of the resultant wall shear mapped onto the channel surface in accordance with Example 7;

FIG. 16 is a top view graphical representation of the resultant wall shear mapped onto the channel surface in accordance with Example 8, wherein the Figure includes a shading key indicating ranges of wall shear;

FIG. 17 is a top view graphical representation of the resultant wall shear mapped onto the channel surface in accordance with Example 9, wherein the Figure includes a shading key indicating ranges of wall shear;

FIG. 18 is a top view graphical representation of the resultant wall shear mapped onto the channel surface in accordance with Example 10, wherein the Figure includes a shading key indicating ranges of wall shear;

FIG. 19 is a top view graphical representation of the resultant wall shear mapped onto the channel surface in accordance with Example 11, wherein the Figure includes a shading key indicating ranges of wall shear;

FIG. 20 is a top view graphical representation of the resultant wall shear mapped onto the channel surface in accordance with Example 12, wherein the Figure includes a shading key indicating ranges of wall shear;

FIG. 21 is a top view graphical representation of the resultant wall shear mapped onto the channel surface in accordance with Example 13, wherein the Figure includes a shading key indicating ranges of wall shear;

FIG. 22 is a top view of a manifold having a plurality of sensor ports in accordance with the invention;

FIG. 23 is a series of views depicting alternative forms of deflection formation in accordance with the invention; and

FIG. 24 is a venturi type deflection formation in accordance with the invention.

### PREFERRED EMBODIMENTS OF THE INVENTION

The invention is directed toward a fouling resistant manifold for mounting a fluid monitoring sensor used to monitor various fluid parameters of a fluid flowing within a fluid channel of the manifold.

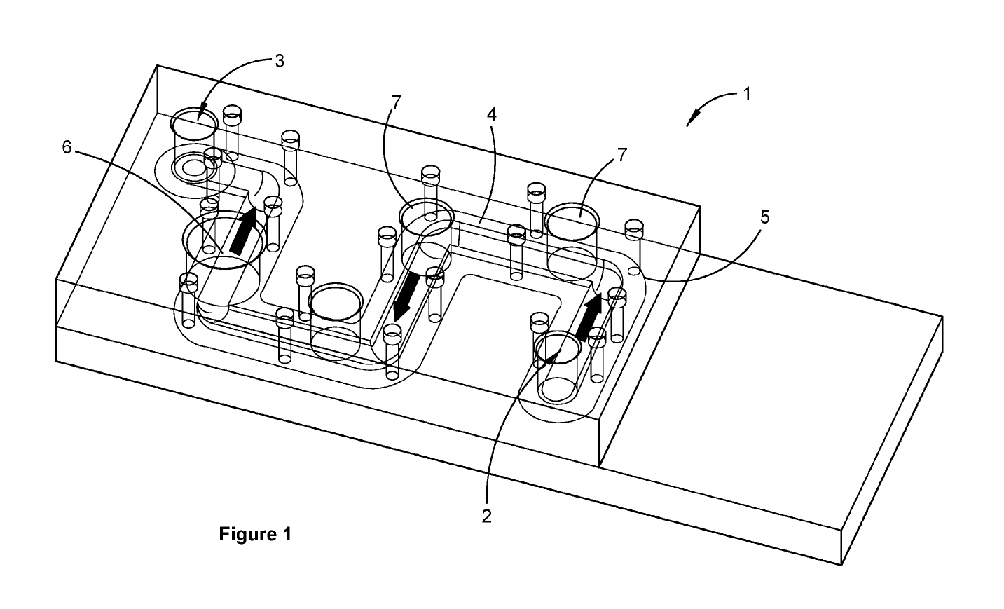

One preferred embodiment of the invention is shown in FIG. 1. The manifold 1 includes a fluid inlet 2 and a fluid outlet 3 connected by a fluid channel 4. A manifold wall 5 having an inner channel surface 6 defines the fluid channel 4. The manifold includes at least one sensor mounting area or, as shown in FIG. 1, a plurality of sensor mounting areas 7. To facilitate sensor exposure to the fluid in the channel, each sensor mounting area 7 may be provided with at least one aperture or port in the manifold wall 5. Of course, some types of sensor may not require direct contact with the fluid and may operate equally well through the manifold wall. While FIG. 1 shows a single port at each mounting area, multiple ports and/or sensors may be located at each of the sensor mounting areas.

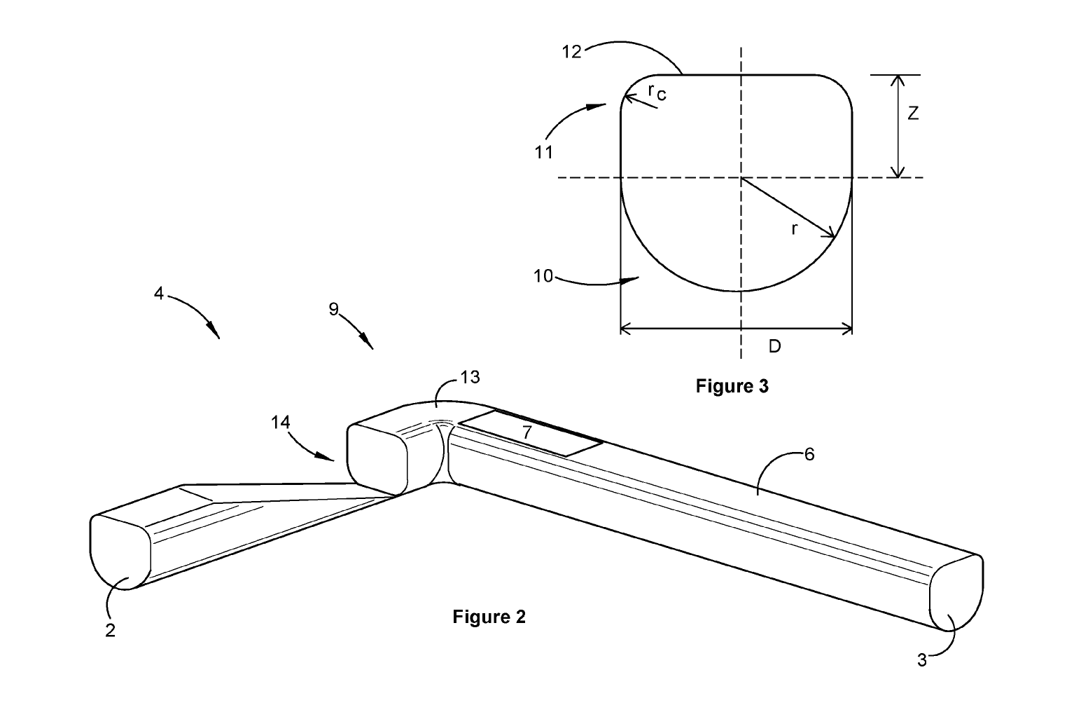

FIG. 2 displays another preferred embodiment of the invention. However, in this figure for clarity, the manifold and manifold wall 5 have been removed to reveal the shape of the three dimensional channel 4 as a volume that is defined by the inner surface 6 of the omitted manifold wall 5. This volume also represents the channel/manifold wall interface and as such, the inner surface 6 of the channel as defined by the manifold wall. The manifold is configured for fluid flow from the inlet 2 to the outlet 3. The position of a sensor mounting area 7 is shown on the surface of the channel 4.

It will be appreciated that it is the shape of the channel 4 defined by the manifold rather than the external shape or appearance of the manifold which is significant in determining the internal flow characteristics of the manifold. Hence the figures used in the examples presented below display the shape and dimensions of the channel volume as would be defined by a respective manifold.

The term “manifold” as used herein is intended to convey any flow-through conduit on which a sensor is mounted thereby providing the sensor with exposure to the fluid. As such “manifold” would equally include any section of a main line conduit for mounting a sensor, as well as an auxiliary conduit arrangement specifically designed for drawing a portion of fluid from a main flow line to be presented to the sensor and then returned to the main flow, or otherwise. The manifold or conduit in this context may therefore have one or more fluid inlets and one or more fluid outlets.

Furthermore, the term “exposure” includes any operational exposure as required by a sensor in order to function effectively as intended. “Exposure” may therefore include physical contact with the fluid flow or exposure by close proximity through an optically transparent window or the manifold wall. The type of exposure required will depend on the operational characteristics of the particular sensor.

Referring to FIG. 2, the manifold channel 4 defines a fluid flow path from the fluid inlet 2 to the fluid outlet 3. A flow deflection formation 9 is included to control the flow characteristics of the fluid in selected regions of the channel. In particular, the deflection formation is disposed upstream of the respective sensor mounting area 7 to accelerate a stream of the fluid. The resultant change in velocity gradient of the fluid stream caused by the acceleration of the fluid induces a localised increase in shear stress immediately adjacent the manifold wall, referred to as wall shear, at predetermined sensor mounting area 7 of the channel surface 6. The flow deflection formation is also configured to minimise direct impact of fouling material onto the sensor mounting area and therefore the sensor surfaces.

Wall shear in respect of the invention refers to shear stress that the moving fluid (with a substantially constant viscosity) imparts onto the inner surface of the wall defining the channel, at a specified location. It has been found that increasing the wall shear reduces the tendency for suspended matter in the fluid to attach to the channel surface and also may provide a cleaning effect by dislodging any matter that does accumulate.

Clearly the invention may not eliminate fouling in all situations because the tendency for fouling depends on a range of factors including but not limited to the nature of the fluid, the overall flow rate of the fluid and channel diameter, the surface properties of the channel wall, the inherent stickiness of the fouling matter, temperature, viscosity etc. The aim of the invention is, however, to employ a deflection formation in the channel upstream of the sensor mounting area to induce an increase in the average wall shear exerted on the manifold wall within the sensor mounting area when compared to the average wall shear exerted on the manifold wall within the same sensor mounting area in the absence of the deflection formation, thereby reducing the propensity for fouling in the vicinity of the sensor.

The deflection formation 9 may take a variety of forms including one or more of: an elbow bend in the manifold channel; a constriction of the channel; a venturi formation; baffles, deflection surfaces, vanes and/or fins; modifications to the channel cross-section shape or profile of the internal surface 6; channel ribbing or rifling; a nozzle; and/or other features, formations or devices, adapted individually or in combination to induce the specified effect on the fluid in the vicinity of the sensor mounting area.

For instance, fluid flow around an elbow bend is rarely uniform and usually includes different areas of fluid flowing at comparatively different speeds and directions. In the context of the invention, the uneven flow distribution is exploited to provide increased levels of wall shear at particular locations in the channel downstream of the bend. Similarly, venturi formations or channel constructions can be used to increase dynamic pressure all wall shear at particular areas. Vanes, fins, surface formations and channel shapes can be used to direct fluid within the channel, to create defined areas of increased wall shear, while nozzles may be used to direct a comparatively high velocity jet of fluid, with respect to the baseline flow in the channel, over targeted sensor mounting areas. Accordingly the shear stress induced at the sensor mounting area is greater than the average shear stress imparted to the manifold wall within the manifold.

The invention may be used for a wide variety of sensors for monitoring various parameters of the fluid flowing through the manifold. Such sensors include but are not limited to sensors for monitoring fluid: flow rate, temperature, pressure, viscosity, acidity (pH), transparency, dissolved oxygen (DO) concentration, oxidation reduction potential (ORP) and/or turbidity.

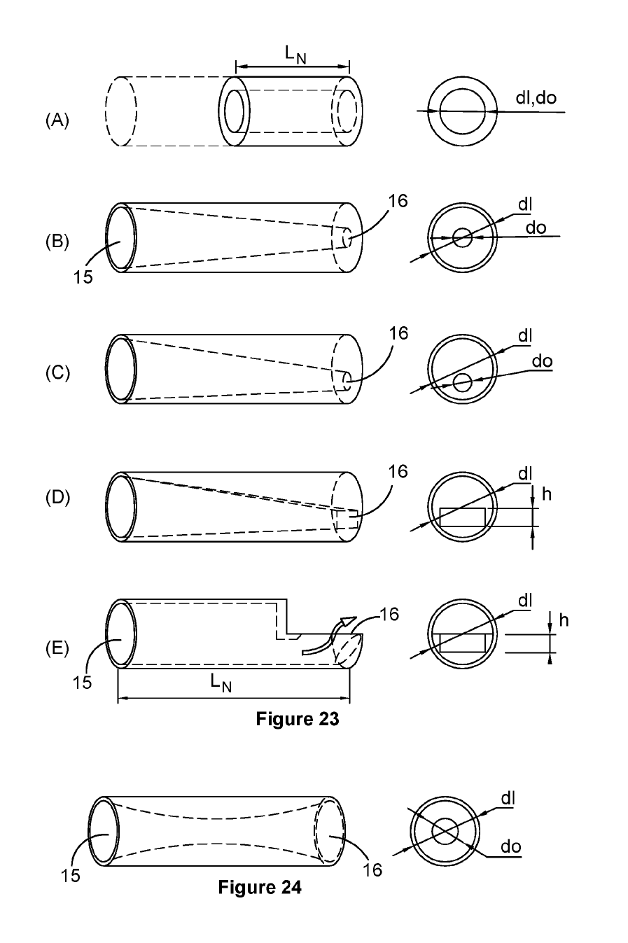

Various examples of flow deflection formations are shown in FIG. 23. FIG. 23A displays a stepped reduction nozzle or plug insert of length L_{N}, outside or inlet diameter of d_{I} and outlet diameter of d_{O}. In this particular embodiment, L_{N} is around 5 cm while d_{I} and d_{O} are around 1.5 cm and 1 cm respectively.

FIG. 23B shows a conical nozzle with circular inlet/outlet. The nozzle tapers from the inlet to the outlet thereby reducing the cross sectional area of the channel/nozzle by a nozzle reduction ratio. For instance, a circular channel and nozzle as shown in FIG. 23B has a nozzle reduction ratio given by (d_{I}/d_{O})². In one embodiment, for instance, d_{I} is around 15.3 mm while d_{O} is around 4 mm providing a nozzle reduction ratio of 14.6 or around 15. It is also noted that the nozzle outlet is generally centrally, coaxially positioned in the channel.

FIG. 23C shows a similar conical reduction nozzle. However the outlet of the nozzle in this case is offset from the channel centre. The nozzle outlet in FIG. 23C is circular while the nozzle shown in FIG. 23D includes a rectangular outlet.

FIG. 23E shows a nozzle having a stepped reduction in cross section and includes an outlet generally perpendicular to the longitudinal axis of the channel. FIG. 24 is a venturi type device.

It will be appreciated that while the examples shown in FIGS. 23 and 24 are illustrated as plug inserts to be inserted into a channel of corresponding diameter, they could equally be formed integrally with the channel wall as part of the manifold. These formations may also be used in conjunction with other complementary flow deflection devices, such as specifically configured pipe bends, and/or internal channel profiles, to induce the desired flow characteristics in the vicinity of the sensor mounting area, as described more fully below. The manifold is thereby resistant to the effects of sensor fouling and consequentially reduced flow rates, advantageously allowing it to operate for comparatively extended periods without maintenance and/or cleaning. In this regard, while the invention may be used for a wide range of fluids, its potential advantages may only be realised when used in conjunction with fluids which by nature are prone to fouling the conduits in which they flow. As previously noted, such fluids include but are not limited to sewage, effluent and grey water which require long-term and constant monitoring for effective management. Many of these types of fluids include greasy and/or fatty fouling material that along with microorganisms and biofilms are prone to accumulating on the internal surfaces of pipes and the manifolds in or to which sensors are mounted.

Turning now to describe the apparatus in more detail, the sensor mounting area 7 includes a sensor mounting port for mounting a sensor. Preferably, the mounting area is a generally flat surface which can be advantageous for aligning and mounting the sensor flush with the inner channel surface. However, providing a flat sensor mounting surface may also influence the shape of the channel. For instance, FIG. 3 displays a sectional view of the channel 4 in one form of the invention.

The channel in this embodiment is generally circular, however as illustrated, has a generally D-shaped cross section comprising a rounded semi-circular portion 10, at the bottom as shown on the page, and an upper, squarish portion 11 including a generally flat section 12. While other shapes may be used, here, the flat section 12 provides the channel with a generally planar surface for sensor mounting while the opposing rounded side of the manifold is volumetrically efficient and also, as will be seen, can enhance vortex flow generation following a bend in the manifold by acting as a deflection surface, particularly in combination with the planar top surface. Otherwise, the width and height of the channel are generally equivalent. As such, the channel can be referred to herein as having a diameter D although it may not strictly have a circular cross section.

As shown in FIG. 2, the generally flat planar surface may extend over the length of the channel to provide a channel having a constant cross section. However, it will also be appreciated that this may not always be the case and that in some embodiments, the cross section of the channel may vary significantly along its length. For instance, the channel may include a portion for sensor mounting comprising a length of channel having a U-shaped cross-section, and revert to a volumetrically efficient circular cross section for the remaining portion of the manifold.

The channel shown in FIGS. 2 and 3 provides for comparatively easy sensor access from above. However the sensors could alternatively be mounted and/or the planar surface provided, at any orientation as required. For instance, inverting the manifold would present the planar sensor mounting surface facing downward thereby providing access from underneath.

As noted, the deflection formation may take a variety of forms, and may comprise one or more elements, used in combination or separately. In one form the deflection formation is a simple elbow bend 13 in the fluid channel. In another form, the deflection formation is a fluid nozzle or internal jet 14. In still further embodiments, as shown in FIG. 2, a combination of an elbow bend and a nozzle is used.

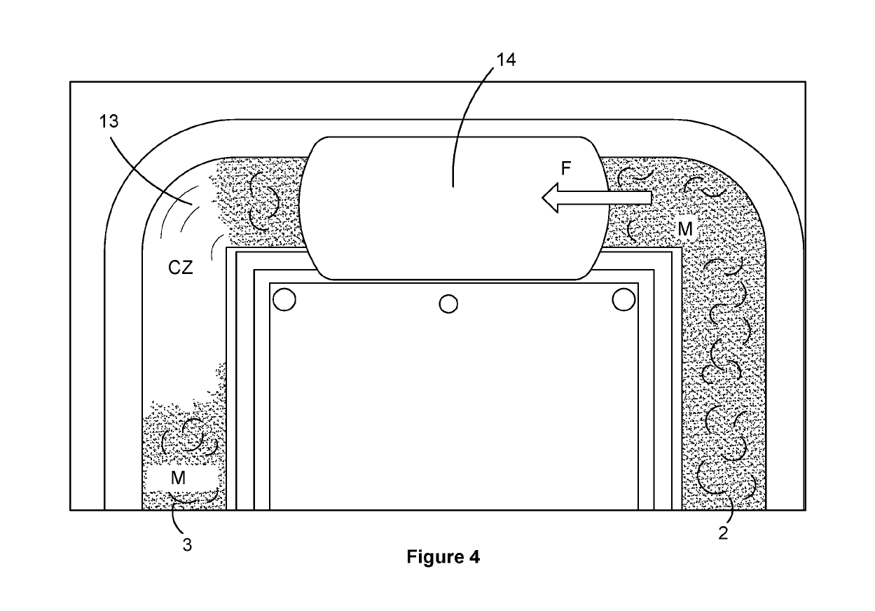

FIG. 4 shows an embodiment of the manifold having both an elbow bend and an internal fluid nozzle. The direction of flow is indicated by arrow (F). As can be seen, fouling matter (M) impinges and accumulates near the entrance to each bend, while a zone of increased wall shear is generated after the bend exit. The increased level of wall shear results in an inherent cleaning effect on the inner surface shown as clean zone (CZ). Locating the sensor mounting area 7 and the sensors in the clean zone of increased wall shear, prevents or reduces the tendency for build-up of material on the sensor.

As a starting point, testing of the embodiments of the manifold demonstrated that cleaning of the channel walls occurred at 15-25 l/min for a bare elbow and 6-8 l/min for a nozzle and elbow in combination. Computational Fluid Dynamics (CFD) analysis was used to illustrate ranges, in terms of physical size, elbow angle and flow rate, over which the same cleaning action can be reproduced in the channel. In this and all examples herein, the fluid is assumed to be Newtonian having a viscosity of water.

### EXAMPLES

It is not possible to illustrate every conceivable form of the manifold. However, in support of the invention, several illustrative examples are now presented and summarised in the table below.

| | Nozzle | Pipe | Elbow | | Flow | |
|---|---|---|---|---|---|---|
| | Height | Diameter | Angle | Separation | Rate | |
| Example | [h] | [mm] | [°] | [s] [mm] | [l/min] | Note |
| 1 | Nil | 15.3 | 90 | N/A | 22 | Baseline |
| 2 | Slit (1 mm)* | 15.3 | 0 | 10 | 8 | Nozzle |
| 3 | Slit (1 mm) | 15.3 | 90 | 10 | 8 | Bend + Nozzle |
| 4 | Slit (1 mm) | 15.3 | 45 | 10 | 8 | Elbow bend |
| 5 | Slit (1 mm) | 15.3 | 135 | 10 | 8 | angle |
| 6 | Slit (0.5 mm) | 7.65 | 90 | 5 | 2 | X0.5 |
| 7 | Slit (10 mm) | 153 | 90 | 100 | 800 | X10 |
| 8 | Slit (10 mm) | 153 | 90 | 10 | 800 | X10 |
| 9 | Slit (1 mm) | 15.3 | 90 | 10 | 4 | Flow Rate |
| 10 | Slit (1 mm) | 15.3 | 90 | 10 | 6 | |
| 11 | Slit (3 mm) | 15.3 | 90 | 10 | 6 | Flow rate with |
| 12 | Slit (3 mm) | 15.3 | 90 | 10 | 8 | larger nozzle |
| 13 | Slit (3 mm) | 15.3 | 90 | 10 | 12 | outlet |

*Nozzle is placed along the top flat wall

### Example 1

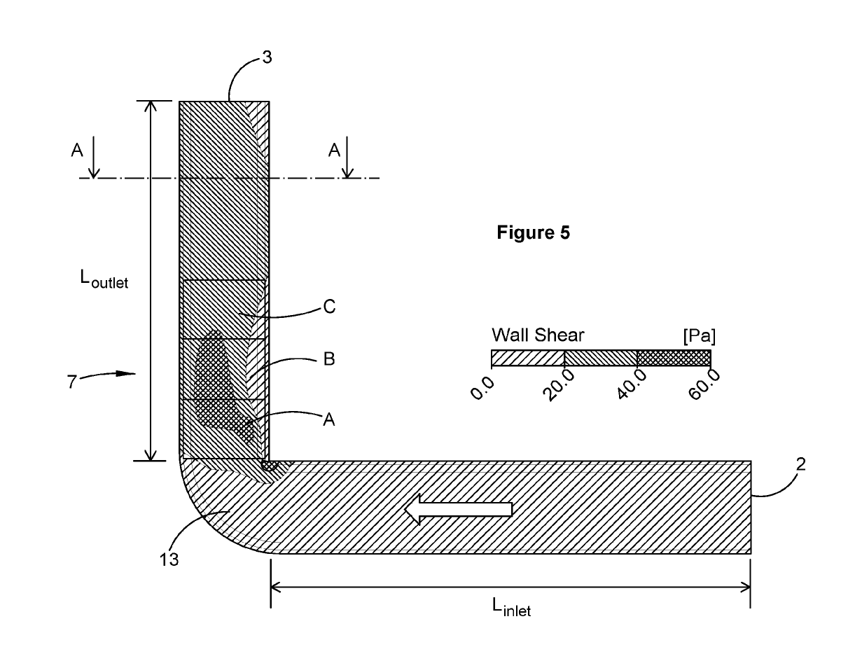

### Baseline Case—Simple Elbow Bend—FIG. 5

In order to quantitatively define the level of cleaning, a simulation was first performed for the bare elbow case at fluid flow rate of 22 l/min. The channel used in this example is shown in FIG. 5 where fluid flows from the inlet 2 to the outlet 3 and includes elbow bend 13. The channel is divided by the bend into an inlet section of length Lᵢₙᵢₑₜ and an outlet section of length Lₒᵤₜₗₑₜ. In the embodiment shown Lᵢₙₗₑₜ is 8 cm and Lₒᵤₜₗₑₜ is 6 cm.

The cross-section of the channel is constant and is shown in FIG. 3. Here the radius (r) of the semi-circular portion is 7.65 mm providing a diameter (D) which determines the width of the channel as 15.3 mm. The height (z) of the square portion is 5.8 mm and each radius r_{c} of the chamfered corners is 2 mm. The bend is preferably 90 degrees but bends of between 45 degrees and 135 degrees may also be applied as will be seen.

The simulated distribution of wall shear stress (τ) is plotted on the channel walls with ranges in Pa as shown by the Wall Shear key. The area of interest is the sensor mounting area 7 immediately downstream of the bend. Accordingly the sensor mounting area is divided into zones, increasing in distance from the bend. In FIG. 5, three equally sized zones have been predetermined with boundaries selected at equally increasing distances from the bend. Distances from the bend exit are expressed as a function of the diameter D of the channel 4 so as to be scalable with respect to the channel dimensions.
Zone A—0 D to 0.65 D (0 cm to 1 cm)
Zone B—0.65 D to 1.3 D (1 cm to 2 cm)
Zone C—1.3 D to 2D (2 cm to 3 cm)

Each of these zones is area-averaged over three individual zones positioned at 0-1 cm, 1-2 cm and 2-3 cm downstream of the elbow on the flat section of the channel wall (see FIG. 1 for an example). The bend exit is taken to be the point where the channel transitions from a bend or curve to a straight section. These zones represent possible sensor locations. The maximum averaged wall shear value was then used as a benchmark (τ_{crit}) to assess the level of cleaning in all subsequent simulations for different channel designs. A value exceeding τ_{crit} is then considered to provide stronger cleaning than that experimentally observed in a bare elbow at high flow (>22 l/min).

In FIG. 5, ranges of wall shear are mapped on the surface of the channel with shading. The darker areas display higher wall shear values, whilst the lighter areas are of lower shear stress as indicated by the key.

From the figure, it can clearly be seen that a zone of comparative higher wall shear is generated after the exit of the bend. As noted above, the wall shear is caused by uneven distribution of flow velocity in the channel immediately downstream of the bend, partially enhanced by the fluid in the bend striking the curved lower rear channel wall of the bend and being deflected upwardly. It is noted that the asymmetrical cross section of the channel means that this deflection effect provided by the lower side wall is not balanced by an equal but opposite deflection of the upper sidewall. The increased level of wall shear results in a reduction of the tendency for the channel surface to accumulate fouling matter in that area.

While the figure shows the pattern of wall shear values mapped onto the channel surface, the averaged wall shear is also calculated for each of Zones A, B and C. In this regard the channel generates an average wall shear of 34 Pa in both Zone A and Zone B. This value is known to reduce fouling in real test cases. Accordingly, it is used as a baseline critical value for the wall shear (τ_{crit}) in all subsequent examples. Wall shear above τ_{crit} is considered sufficient to reduced or eliminate fouling build up.

At 22 l/min, the predicted pressure drop is 2.2 kPa.

### Example 2

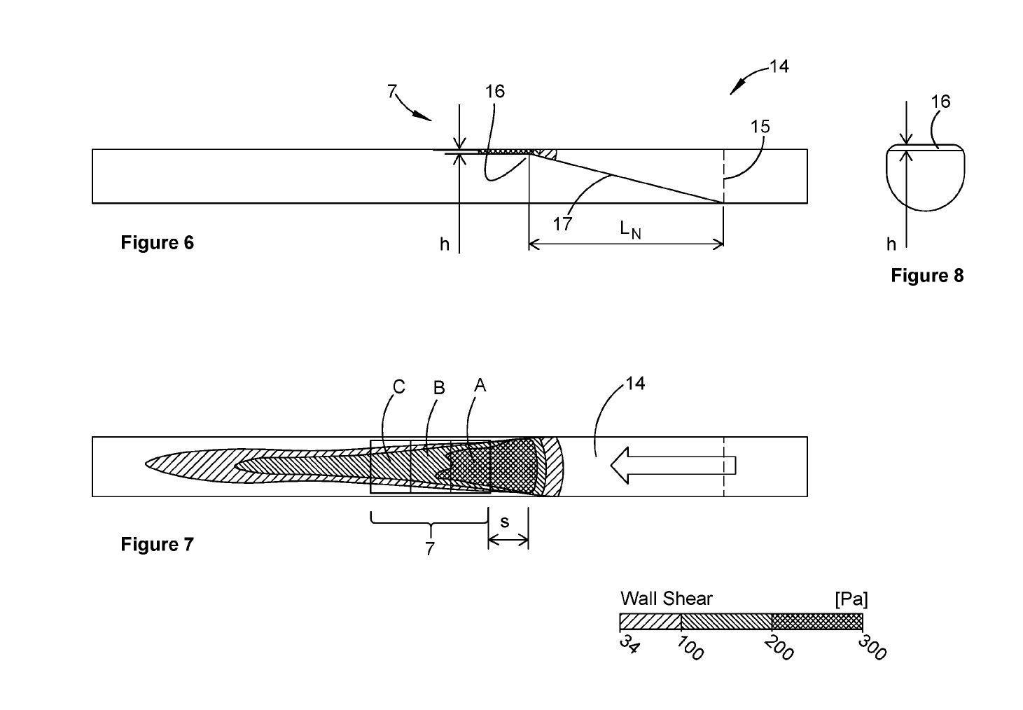

### Internal Nozzle—FIGS. 6, 7 & 8

As noted, in another form, the deflection formation is an internal fluid nozzle 14. The nozzle is configured to direct fluid to generate higher shear in the sensor mounting area 7.

An example of an internal fluid nozzle is shown in FIGS. 6, 7 and 8 which show respective side, top and cross sectional end views of a straight channel of generally uniform cross-section other than the nozzle section, as will be explained. The cross-sectional profile of the channel shown in FIG. 8 is identical to that from Example 1 and shown in FIG. 3.

In this configuration, a nozzle 14 includes a tapered section between a nozzle inlet 15 and a nozzle outlet 16. The taper is generally formed by the intersection of an angled planar surface 17 with the channel which acts as a ramp of length L_{N} extending along the length of the channel. As can be seen in FIG. 8 the nozzle outlet 16 is formed as an elongate slit positioned adjacent the planar channel wall. In this embodiment L_{N} is 5 cm and the ramp begins 2 cm downstream of the inlet at the bottom or semicircular portion and is angled toward the square, upper portion of the channel ending 1 mm before the channel roof thereby forming the nozzle outlet as a slit 1 mm in height (h=1 mm) with a cross sectional area of 12.5 mm². The sensor mounting area 7 is positioned by separation distance s, 1 cm downstream of the nozzle and is split into zones A, B and C as per Example 1.

The reduction in cross-sectional area in the nozzle causes an increase in fluid flow velocity and wall shear stresses. These were recorded in Zones A, B and C as 170, 125 and 90 Pa respectively which are all well above the calculated minimum value of 34 Pa for τ_{crit}. It should also be noted that these high values of wall shear were simulated at a reduced flow rate of 8 l/min (down from 22 l/min in Example 1).

### Example 3

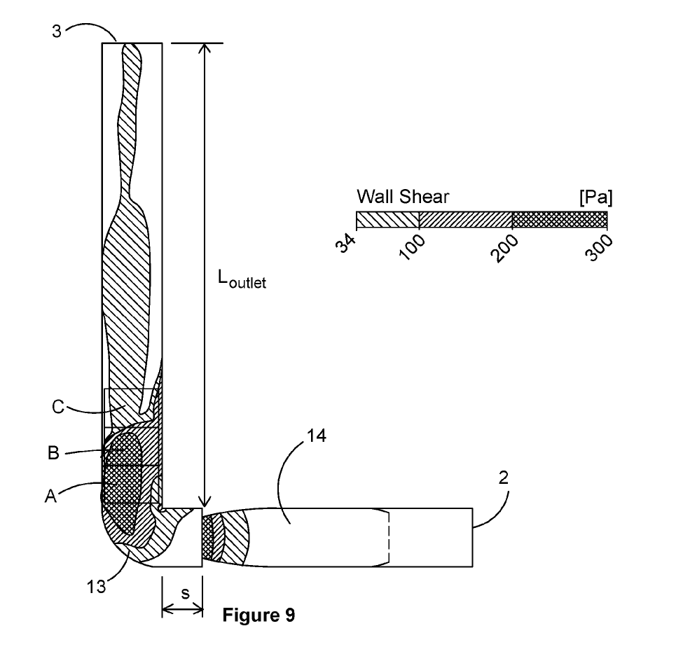

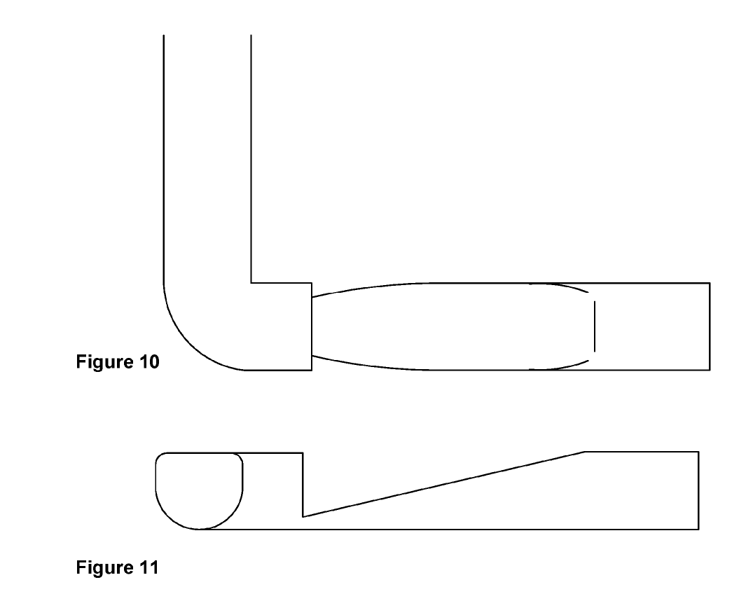

### Offset Nozzle, Elbow and Defection Surface—FIGS. 9, 10 & 11

As previously noted the combination of a nozzle and a bend is also contemplated and shown in FIG. 9. In this example, the nozzle 14 is fitted 1 cm upstream of a 90 degree bend 13. However in contrast to Example 2, the nozzle outlet 16 is configured adjacent the semicircular portion of the channel wall (i.e. opposite the sensor side).

Otherwise the nozzle dimensions are the same as for Example 2, where nozzle length L_{N} is 5 cm and the nozzle outlet is 1 mm in height (h=1 mm) with a cross sectional area of around 12.5 mm². Separation distance s now becomes the nozzle outlet-bend entry displacement but remains at 1 cm.

The channel example 3 is shown in FIG. 9. Here the length Lₒᵤₜₗₑₜ of the outlet section of the channel, after the bend, is 12 cm. FIGS. 10 and 11 show partial views of the channel from the top and side respectively. The exit portion of the channel has been shortened in FIG. 10.

In this configuration, the offset nozzle directs a thin accelerated stream of fluid onto the lower, transverse channel wall at the exit of the bend. The stream sweeps along the channel wall, directly raising wall shear stress along its path. The curved shape of the circular wall in combination with the outer periphery of the bend acts as a deflection surface deflecting the stream upwardly and into the bend exit, initiating a “swirling” or vortex flow around the bend and in the channel downstream of the bend, generally raising the velocity of the fluid adjacent the manifold wall. The vortex is strongest immediately after the bend and particularly at the top planar surface mounting area, dissipating with increasing distance from the bend. However, the higher wall shear stress region persisted for more than 5 channel diameters downstream of the elbow. Accordingly, while the sensor mounting area provides the strongest cleaning action at Zone A of the sensor area, the cleaning effect and potential sensor mounting area is feasible within area B and C and up to 7.5 cm from the bend (5 times D).

The average values of wall shear in Zones A, B and C are 215, 178 and 67 Pa respectively which again are all well above the calculated minimum value of τ_{crit} 34 Pa. As with example 2, it is noted that these high values of wall shear were simulated at a reduced flow rate of 8 l/min (down from 22 l/min in Example 1). By comparison, although not presented herein as an example, placing the nozzle at the top flat side produces stronger cleaning in Zone B.

### Examples 4 & 5

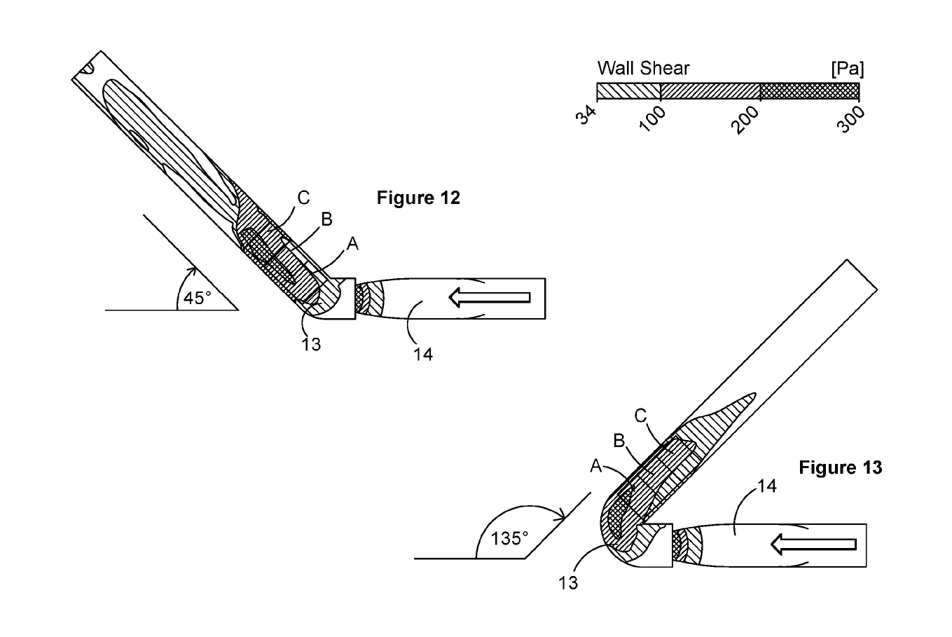

### 45 and 135 Degree Elbow Angle—FIGS. 12 & 13

Examples 4 and 5 display the effect of the angle of the bend 13 of the elbow. The channel of Example 4 as shown in FIG. 12 uses a combination bend and nozzle as per Example 3, however the channel includes an acute bend angle of 45°. In Example 5, shown in FIG. 13, the bend angle is 135°.

The wall shear values are mapped onto the respective 45 degree bend and 135 degree bend channels in FIGS. 12 & 13.

The average values of wall shear in Zones A, B and C are presented in the table below. It is noted that in contrast to all other Examples, the average shear values increased from Zone A to Zone C in Example 4.

| | Example 4 | Example 3 | Example 5 |
|---|---|---|---|
| | Bend angle | Bend angle | Bend angle |
| | (45 degrees) | (90 degrees) | (135 degrees) |
| | FIG. 12 | FIG. 9 | FIG. 13 |
| Zone C (τ)/Pa | 175 | 67 | 110 |
| Zone B (τ)/Pa | 162 | 178 | 138 |
| Zone A (τ)/Pa | 129 | 215 | 159 |

Both acute and obtuse angles reduce the peak shear value. However, the benefit is a more uniform distribution of high wall shear across all three zones. For the 45° elbow case (FIG. 12), the high wall shear region elongated slightly and occurs further downstream of the bend whereas the 135° case in Example 5 shows the higher shear occurring closer to the bend.

### Example 6 & 7

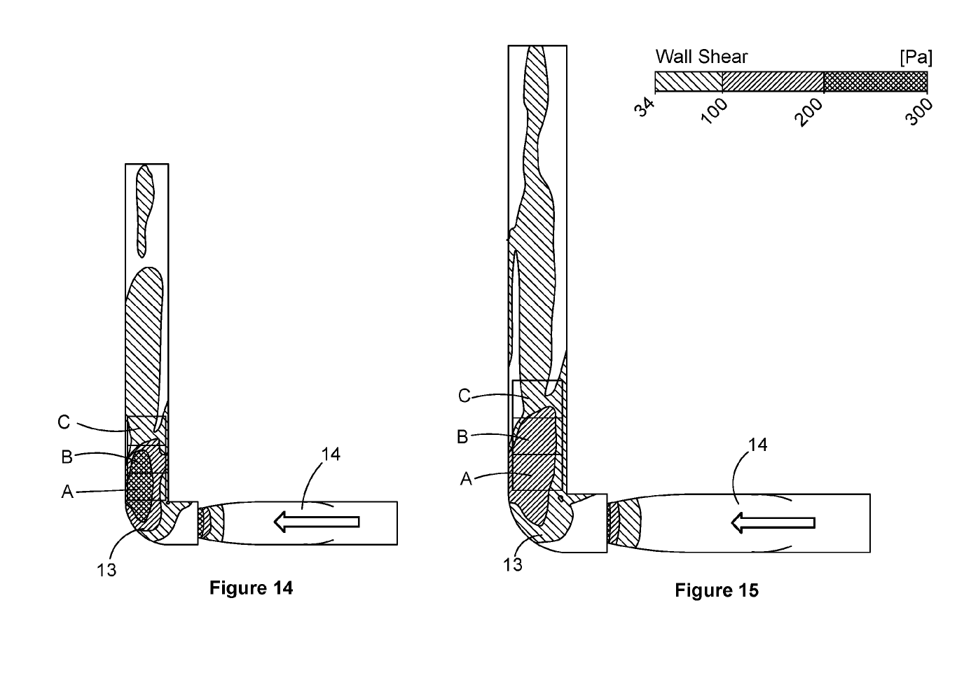

### Scale Effect—FIGS. 14 & 15

The channel and the nozzle were scaled down by a factor of ½ in Example 6 as shown in FIG. 14 and up by a factor of 10 in Example 7 (FIG. 15). A comparative table of dimensions of the channels used in Examples 6 and 7, as compared to Example 3, is presented below.

| | Example 6 | Example 3 | Example 7 |
|---|---|---|---|
| | Scale (½x) | Scale (1x) | Scale (10x) |
| | FIG. 14 | FIG. 9 | FIG. 15 |
| Radius (r)/mm | 3.825 | 7.65 | 76.5 |
| Height (z)/mm | 2.9 | 5.8 | 58 |
| Lᵢₙₗₑₜ/mm | 40 | 80 | 800 |
| Lₒᵤₜₗₑₜ/mm | 30 | 60 | 600 |
| Separation (s)/mm | 5 | 10 | 100 |
| Zone A/mm | 0-5 | 0-10 | 0-100 |
| Zone B/mm | 5-10 | 10-20 | 100-200 |
| Zone C/mm | 10-15 | 20-30 | 200-300 |

The simulated distribution of wall shear stresses (τ) is plotted on the channel walls and shown in FIG. 14 and FIG. 15. It should be noted that FIGS. 14 and 15 are not drawn to comparative scale.

In order to maintain the same fluid flow velocity inside the channel, due to the increase of cross-sectional area, the flow rate was necessarily scaled down and up by factors of ¼ and 100, respectively. Thus the flow rate in Example 6 is 2 l/m and 800 l/min in Example 7.

As can be seen with reference to the figures, the wall shear pattern is relatively similar as between Examples 3, 6 and 7 in that the high wall shear stress regions are located within the sensor area and particularly Zones A and B, dropping in Zones C.

| | Example 6 | Example 3 | Example 7 |
|---|---|---|---|
| | Scale (½x) | Scale (1x) | Scale (10x) |
| | FIG. 14 | FIG. 9 | FIG. 15 |
| Zone C (τ)/Pa | 65 | 67 | 58 |
| Zone B (τ)/Pa | 162 | 178 | 121 |
| Zone A (τ)/Pa | 204 | 215 | 129 |

In all cases, the averaged wall shear peaked in Zone A. However, the value is smaller at larger (×10) scale (Example 7), indicating that the underlying flow pattern does not scale up linearly with channel size and hence the wall shear level does not remain the same for a larger channel diameter. Nevertheless, the averaged wall shears within the three windows were all well above τ_{crit} for the three channel diameters tested. It is therefore reasonable to expect effective cleaning of the channel wall for channel diameters ranging between around 7 mm and at least around 150 mm. It is important to note that sizes of the zones were also scaled relative to the channel.

### Example 8

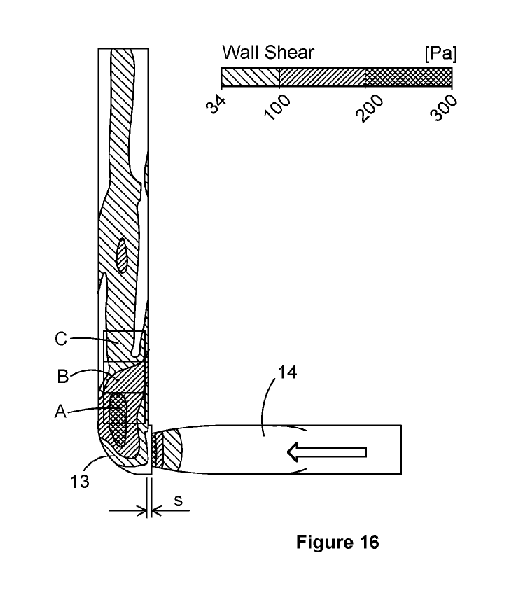

### Reduced Slit to Bend Distance—FIG. 16

One of the effects of the non-linear nature of the scaling is shown in Example 8. With reference to Example 7, due to the scaling, the separation distance s between nozzle and bend in the ×10 case (Example 7) is 10 cm rather than 1 cm as for the base scale (×1) case in Example 3. Accordingly, dissipation of the stream of fluid from the nozzle is a greater factor at 10 cm than it is with a smaller separation distance s, leading to weaker cleaning downstream of the elbow. In Example 8, shown in FIG. 16, the nozzle separation distance s is reduced by a factor of 10⁻¹ to 1 cm.

The plotted results are presented in FIG. 16 and summarised in the table below. It can be seen that reducing the scaled separation distance s (i.e. from 10 cm to 1 cm upstream of the elbow) reduces spreading and stream decay wall shear, particularly within Zone A (FIG. 16). The average wall shear in each zone A, B and C are presented below. The results of Example 7 are included for comparative illustration.

| | Example 7 | Example 8 |
|---|---|---|
| | Scale (10x) | Scale (10x) |
| | d = 100 mm | d = 10 mm |
| | FIG. 15 | FIG. 16 |
| Zone C (τ)/Pa | 58 | 58 |
| Zone B (τ)/Pa | 121 | 117 |
| Zone A (τ)/Pa | 129 | 168 |

### Example 9 and 10

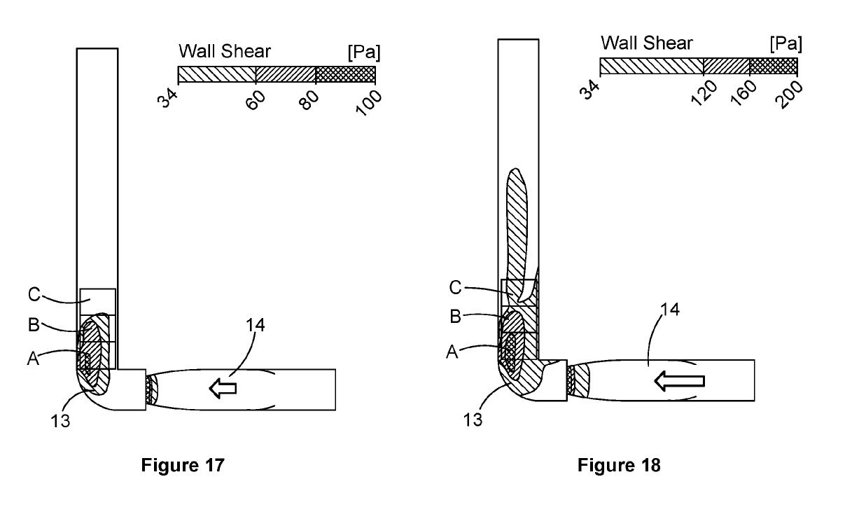

### Effect of Flow Rate—FIGS. 17 & 18

With reference to the average shear in each zone in the previous examples, it is noted that all average values comfortably exceed the minimum value of τ_{crit} (34 Pa) determined as required for effective cleaning. Since flow rate directly affects the level of wall shear and hence cleaning downstream of the elbow, it should be possible to reduce the flow rate while maintaining adequate (but reduced) cleaning. Naturally reducing the flow rate requires less pumping pressure and pumping losses.

Examples 9 and 10 reduce the flow rate from 8 l/min in Example 3, to 4 and 6 l/min respectively whilst using the same channel dimensions as used in Example 3. The channel dimensions in Example 9 & 10 are identical to those of Example 3.

The wall shear contours are presented in FIGS. 17 and 18. The average wall shear stress in each of Zones A, B and C are presented in the table below. Again the results of Example 3 are included for comparative illustration.

As can be seen in the table, at flow rates of 4 l/min the average wall shear is below τ_{crit}. in Zone C but above τ_{crit}. in Zone A and Zone B. This is considered as the minimum water flow rate required to clean Zone A and Zone B similar to that observed for a bare elbow at high flow rate in the laboratory. The required pressure drop at 4 l/min is 15.9 kPa.

Examples 9 & 10 indicate that pumping requirements may be reduced whilst still providing adequate cleaning performance.

| | Example 9 | Example 10 | Example 3 |
|---|---|---|---|
| | Flow Rate | Flow Rate | Flow Rate |
| | (4 l/min) | (6 l/min) | (8 l/min) |
| | FIG. 17 | FIG. 18 | FIG. 9 |
| Zone C (τ)/Pa | 17 | 38 | 67 |
| Zone B (τ)/Pa | 46 | 101 | 178 |
| Zone A (τ)/Pa | 59 | 126 | 215 |

### Examples 11, 12 and 13

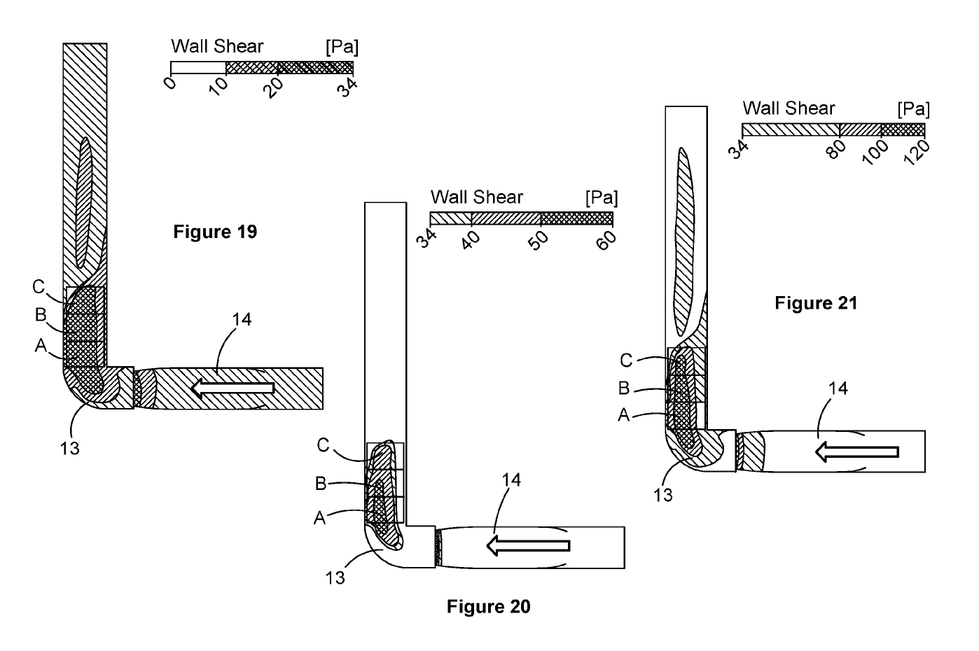

### Effect of Nozzle Outlet Size—FIGS. 19, 20 & 21

Another method for reducing pumping losses is to increase the size of the nozzle outlet. Examples 11, 12 and 13 each use a larger slit width h of 3 mm and flow rates of 6, 8 and 12 l/min respectively.

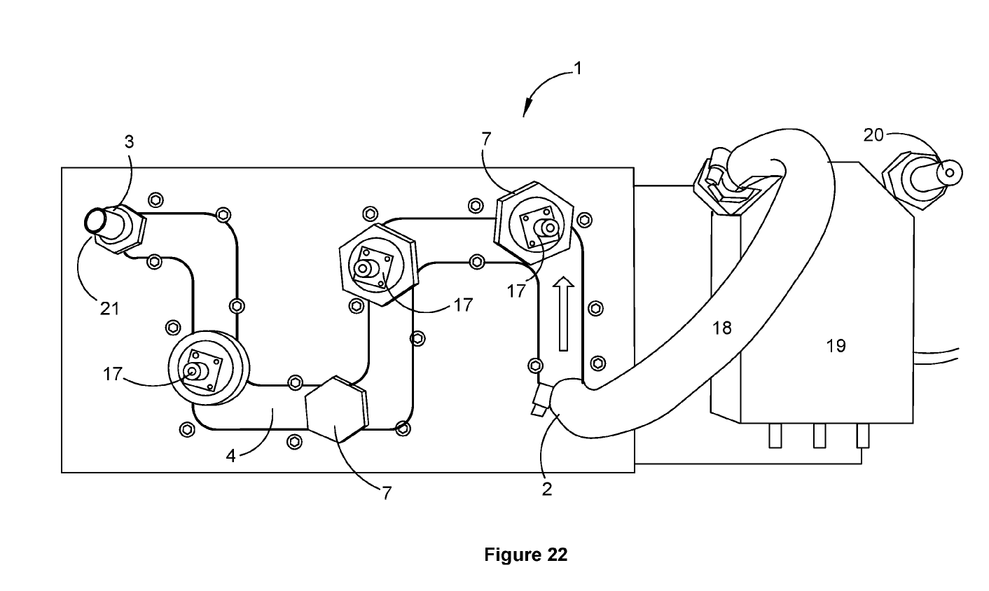

The trade-off of the larger cross-sectional area of the slit is a decrease in the level of wall shear. The simulation results are presented in the table below and shown in the shaded plot in FIGS. 19, 20 and 21 corresponding to Examples 11, 12 and 13 respectively.

| | Example 11 | Example 12 | Example 13 |
|---|---|---|---|
| | Slit (h) 3 mm | Slit (h) 3 mm | Slit (h) 3 mm |
| | Flow Rate | Flow Rate | Flow Rate |
| | (6 l/min) | (8 l/min) | (12 l/min) |
| | FIG. 19 | FIG. 20 | FIG. 21 |
| Zone C (τ)/Pa | 20 | 35 | 76 |
| Zone B (τ)/Pa | 24 | 41 | 86 |
| Zone A (τ)/Pa | 24 | 42 | 90 |

The results show that to achieve τ_{crit}, the channel needs to operate at a minimum flow rate of 8 l/min. Variation in the averaged wall shear across the three windows is less than 17% as compared to 72% in the 1 mm slit case (FIG. 6). The pressure drop required at 6, 8 and 12 l/min is 3.9, 6.9 and 15.5 kPa, respectively.

Manifold Working Range

Based on the above examples, working ranges of the channel with an elbow and slit nozzle have been established in the table below.

| | | | Optimum (the |
|---|---|---|---|
| | | | parameter that |
| | | | works best in the |
| | Minimum | Maximum | tested system) |
| Diameter of Pipe (D) [mm] | 7.65 | 153 | 15.3 |
| Flow Rate [l/min] | 4 | 8 | >4 |
| (15.3 mm channel, 1 mm slit) | | | |
| Flow Rate [l/min] | 8 | 12 | >8 |
| (15.3 mm channel, 3 mm slit) | | | |
| Elbow turning angle (in system that | 45° | 135° | 90° |
| has an elbow) | | | |
| Distance from end of the slit to the | 0.065 D | 0.65 D | <0.65 D |
| beginning of the elbow | (153 mm case) | (15.3 mm case) | |
| Distance from the end of the elbow | 0 D | >2.5 D (1.3 D) | 0.33 D |
| to the centre of the clean | | | (5 mm/15.3 mm) |
| zone/sensor location | | | |

D = channel diameter (15.3 mm for X1 case)

Referring to the table, in an optimised example of the invention the manifold channel is generally circular or square in cross section. The diameter (or maximum width) D of the channel is between around 7 mm and 15 cm.

The manifold includes a composite deflection formation comprising two discrete but synergistically interactive deflection elements; an elbow bend and an upstream nozzle defining a nozzle outlet for directing a stream of liquid adjacent and along a wall of the channel and into the bend. The nozzle outlet is spaced from the bend by a distance of between 0 and around 0.65 times the channel diameter D.

The bend provides a directional change of the channel in an angular range of around 45° and around 135°. The nozzle provides a reduction ratio, corresponding to the ratio of the cross-sectional area of the channel to the cross-sectional area of the nozzle outlet, of between 4 and around 15. The nozzle outlet is preferably elongate having a transverse width of between 0.03 D and around 0.2 D. The sensor mounting area is disposed adjacent and immediately downstream of the elbow bend exit, within a distance corresponding to 5 times the diameter D of the channel.

In one form, the manifold may be connected to a primary fluid conduit to define an auxiliary flow path such that only a proportion of fluid is drawn from the primary flow and directed through the manifold, for monitoring. Fluid may be drawn off passively by relying upon pressure differentials and/or flow in the primary conduit, or actively by use of a fluid pumping device. In another form, the manifold is incorporated into, is integral with, or simply constitutes part of, the main conduit.

FIG. 22 shows a manifold design in accordance with the invention which is suitable for a plurality of sensors. By alternating the direction of successive bends the manifold defines a serpentine flow path, incorporating multiple sensor mounting areas, within a relatively compact topography.

More specifically, the manifold passageway 4 includes four sensor mounting areas 7 each having a respective sensor mounting port and sensor module 17. It is noted that each of the sensor mounting areas is located after a respective deflection formation in the form of a respective elbow bend 13. While this particular manifold does not include nozzle type deflection formations, the manifold could be modified to include one or more formations associated with one or more sensor mounting areas.

The fluid inlet 2 is connected by means of hose 18 to the outlet of a fluid pump 19. The pump 19 draws fluid from a fluid source to be monitored. Pump inlet 20 can be seen, which may be connected by means of a hose (not shown) to a tank or reservoir, or a bleed from a primary fluid pipe. Another hose (not shown) connects the manifold outlet 3 by means of fitting 21 to return fluid to the source or primary supply. In other cases the pump may not be required and instead the fluid flows through the manifold due to pressure differentials at the inlet 2 and outlet 3.

The invention in its various preferred embodiments provides a manifold for directing a fluid to a sensor mounted on the manifold, in a unique manner that both resists fouling and avoids damage to sensitive sensors. This in turn minimises the need for maintenance and repairs. Advantageously, the apparatus works well for robust sensors in a variety of liquids including those containing greasy/fatty suspended matter. It is also suitable for sensors having flexible or otherwise sensitive fluid interfaces (e.g. polymer membranes) as it avoids direct flow impingement from wall jets that can disrupt or damage these sensitive surfaces. Moreover, these advantages can be achieved in a reliable and cost-effective manner, and at reduced flow rates than otherwise might be required. The invention thus represents a practical and commercially significant improvement over the prior art.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, although the invention has been described with reference to specific examples, it will be appreciated by those skilled in the art that invention may be embodied in many other forms.

1. A fouling resistant sensor manifold for directing a fluid to a sensor mounted on the manifold, said manifold including:
a fluid inlet;
a fluid outlet;
a fluid channel connecting the inlet to the outlet;
a manifold wall defining an inner channel surface including a sensor mounting area for mounting the sensor for exposure to fluid flowing through the channel;
a deflection formation disposed upstream of the sensor mounting area to accelerate a stream of the fluid, whereby a resultant change in velocity gradient of the fluid stream induces a localised increase in wall shear at the sensor mounting area, thereby in use to resist fouling of the sensor.

2. The sensor manifold of claim 1 wherein said deflection formation includes one or more of: an elbow bend in the manifold channel; a constriction of the channel; a venturi formation; a baffle; a deflection surface; a deflection vane; a fin; a change in channel cross-sectional profile; a wall surface finish; channel rifling and/or a nozzle formation.

3. The sensor manifold of claim 1, wherein said deflection formation includes a bend in the fluid channel and wherein the bend is between 45 degrees and around 135 degrees.

4-6. (canceled)

7. The sensor manifold of claim 3 wherein the bend is around 90 degrees.

8. The sensor manifold of claim 1 wherein said deflection formation includes a constriction of said channel to accelerate said stream.

9-23. (canceled)

24. The sensor manifold of claim 1 wherein said deflection formation is adapted to initiate a downstream vortex flow.

25. The sensor manifold of claim 1 wherein the channel is generally circular or square in cross section having a maximum width of D and the sensor mounting area is disposed within a distance of 5D downstream of the deflection formation.

26-28. (canceled)

29. The sensor manifold of claim 1 wherein the channel is generally circular or square in cross section having a maximum width of D and wherein the sensor mounting area is disposed within a distance of 2D downstream of the deflection formation.

30. (canceled)

31. The sensor manifold of claim 1 wherein the channel is generally circular or square in cross section having a maximum width of D between 7 mm and around 15 cm.

32. The sensor manifold of claim 1 wherein the channel is generally circular or square in cross section having a maximum width of D of around 1.5 cm.

33. The sensor manifold of claim 1 wherein the average wall shear at the sensor mounting area is greater than around 25 Pa.

34. The sensor manifold of claim 1 wherein the average wall shear at the sensor mounting area is greater than around 34 Pa.

35. The sensor manifold of claim 8 wherein said constriction includes a nozzle having a nozzle inlet upstream of a nozzle outlet for directing said stream and wherein said nozzle provides a nozzle reduction ratio of the channel cross-sectional area with respect to the nozzle outlet cross-sectional area of greater than 1.

36. The sensor manifold of claim 35 wherein the nozzle reduction ratio is greater than 4.

37. The sensor manifold of claim 35 wherein said nozzle includes a stepped change in cross sectional area between the nozzle inlet and the nozzle outlet.

38. The sensor manifold of claim 35 wherein said nozzle tapers progressively from the nozzle inlet to the nozzle outlet.

39. The sensor manifold of claim 35 wherein the nozzle outlet is offset from the centre of the channel.

40. The sensor manifold of claim 35 wherein said nozzle outlet is disposed upstream of a defection surface and adapted to direct said accelerated stream onto said deflection surface.

41. The sensor manifold of claim 40 wherein said defection surface is a bend in the fluid channel and said nozzle outlet is disposed upstream of said bend to direct said accelerated stream into said bend.

42. The sensor manifold of claim 35 wherein the channel is generally circular or square in cross section having a maximum width of D and the nozzle has a nozzle length L_{N} of around 3D.
